(19) United States
(12) Patent Application Publication
(10) Pub. No.: US 2014/0380190 A1
(43) Pub. Date: Dec. 25, 2014

(54) INTEGRATING CUSTOMER RELATIONSHIP MANAGEMENT INFORMATION TO COMMUNICATION SESSIONS

(71) Applicant: Microsoft Corporation, Redmond, WA (US)

(72) Inventors: Ron Mondri, Bellevue, WA (US); Madan Natu, Redmond, WA (US)

(21) Appl. No.: 13/923,871

(22) Filed: Jun. 21, 2013

(51) Int. Cl. G06F 3/0484; H04L 29/06

(52) U.S. Cl. CPC G06F 3/0484; H04L 65/403
USPC 715/753

(57) ABSTRACT

Customer relationship management (CRM) information is integrated with communication sessions. A unified communication (UC) client application initiates a call with a contact in response to a request by a CRM application presenting an opportunity associated with the contact. The UC application receives contextual information and documents associated with the opportunity. The contextual information includes attributes and relationship information associated with the opportunity and the contact. Contacts associated with the opportunity is displayed within a user interface (UI) such as a people view. The application provides controls to manage contextual information of the contacts associated with the opportunity. Documents associated with the opportunity are also presented within another UI such as a documents view.

### BACKGROUND

Customer Relationship Management (CRM) solutions provide tools and capabilities needed to create acrd maintain a clear picture of customers, from first contact through purchase and post-sales. For complex organizations, a CRM system may provide features and capabilities to help improve the way sales, marketing, and/or customer service organizations target new customers, manage marketing campaigns, and drive sales activities. CRM systems may include many components, hardware and software, utilized individually or in a shared manner by users internal or external to an organization.

Parallel to advances in CRM solutions, advances in technology have enabled proliferation of cellular phone networks over the last decade as an alternative to Public Switched Telephone Network (PSTN) systems, where users with cellular phones have access to one or more networks at almost any location. Also a recent development is the wide spread use of Voice over IP (VOIP) telephony, which uses internet protocol (IP) over wired and wireless networks. With the availability of such diverse types of communication networks and devices capable of taking advantage of various features of these networks, enhanced communication systems bring different communication networks together providing until now unavailable functionality such as combining various modes of communication (e.g. instant messaging, voice/video communications, data application sharing, white-boarding, and other forms of communication may be combined with presence and availability information of subscribers).

This technology is also referred to as Unified Communications (UC). UC systems provide communication infrastructure to variety of enterprise organizational demands. Expansion in enterprise environments have enabled integration of UC systems with other traditional enterprise resources such as content providers and user account systems. However, integration with CRM systems is presently in its infancy. Legacy CRM solutions seldom interact with external systems to expand utilization of vast information maintained by CRM systems.

### SUMMARY

This summary is provided to introduce a selection of concepts in a simplified form that are further described below in the Detailed Description. This summary is not intended to exclusively identify key features or essential features of the claimed subject matter, nor is it intended as an aid determining the scope of the claimed subject matter.

Embodiments are directed to integrating customer relationship management (CRM) information to communication sessions. A unified communication (UC) client application may initiate a call with a contact in response to a request by a CRM application. The request may include a call identifier (e.g., a phone number) associated with the contact, which may be used to establish the call with the contact. The UC client application may receive contextual information and documents associated with the opportunity. Contextual information may include attributes and relationships of a contact and associated opportunity.

Next, contacts associated with the opportunity may be displayed within a user interface (UI) including a people view. The people view may present the contacts in categories associated with organizational roles associated with the opportunity. In addition, documents associated with the opportunity may be presented within another UI including a documents view. The documents may be presented to participants of the call through document controls displayed by the documents view.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating an example enhanced communications system such as a unified communication (UC) system, where embodiments may be implemented for integrating customer relationship management (CRM) information to communication sessions;

FIG. 2 is an example user interface of a CRM application providing communication controls to integrate CRM information to communication sessions, according to embodiments;

FIG. 3 illustrates an example of integrating CRM information to communication sessions presenting contacts associated with an opportunity, according to embodiments;

FIG. 4 illustrates another example of integrating CRM information to communication sessions presenting documents associated with an opportunity, according to embodiments;

FIG. 5 is a simplified networked environment, where a system according to embodiments may be implemented;

FIG. 6 is a block diagram of an example computing operating environment, where embodiments may be implemented; and

FIG. 7 illustrates a logic flow diagram for a process of integrating CRM information with communication sessions according to embodiments.

### DETAILED DESCRIPTION

As briefly described above, communication sessions may be integrated with customer relationship management (CRM) information. A unified communications (UC) client application may initiate a call with a contact in response to a request by the CRM application. The UC client application may receive contextual information and documents associated with an opportunity associated with the contact. The application may display the contacts within a user interfaces (UI) including a people view and the documents in another UI including a documents view.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, and a flash drive.

Throughout this specification, the term “platform” may be a combination of software and hardware components for integrating CRM information with communication sessions. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

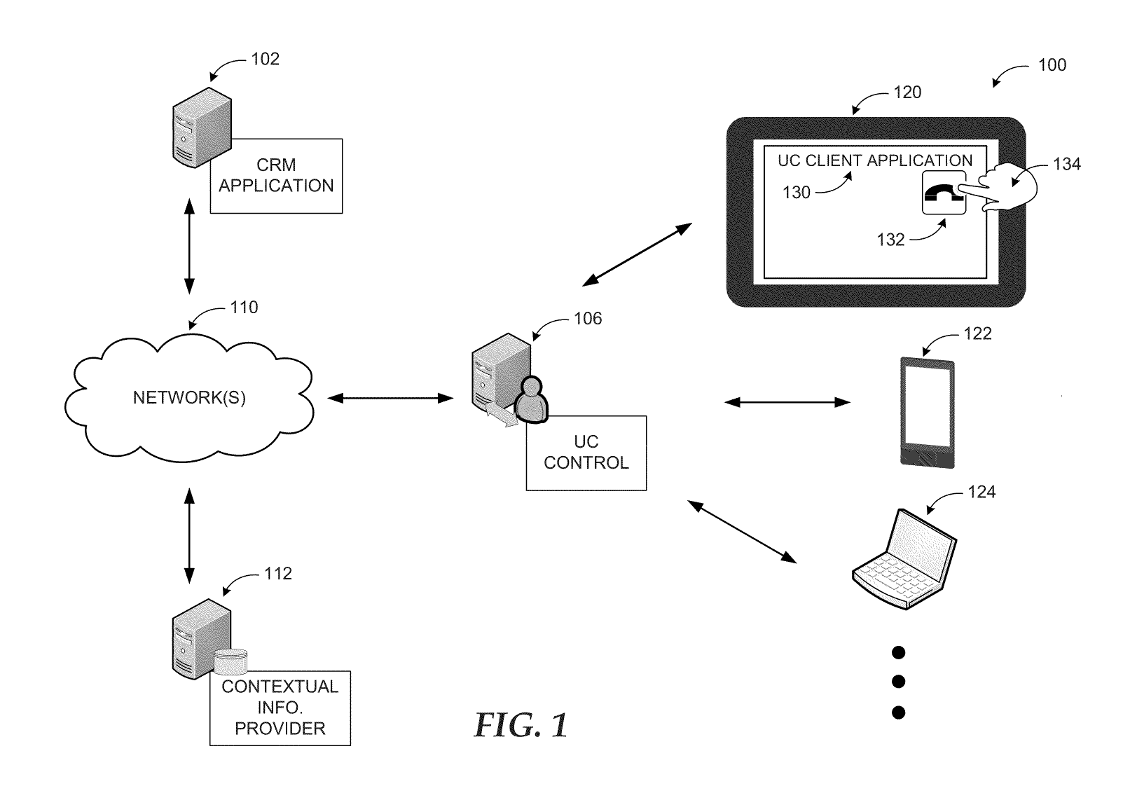

FIG. 1 includes diagram 100 illustrating an example enhanced communications system such as a UC system, where embodiments may be implemented for integrating CRM information with communication sessions. A unified communication (UC) system is an example of modern communication systems with a wide range of capabilities and services that cart be provided to subscribers. A unified communication system is a real-time communications system facilitating email exchange, instant messaging, presence, audio-video conferencing, web conferencing, and similar functionalities.

In a unified communication (UC) system such as the one shown in diagram 100, users may communicate via a variety of end devices including a tablet 120, a smart phone 122, and a laptop computer 124 which are client devices of the UC system. Each client device may be capable of executing one or more communication applications such as UC client application 130 for voice communication, video communication, instant messaging, application sharing, data sharing, and similar ones. Client devices 120, 122, 124 may include any type of smart phone, cellular phone, any computing device executing a communication application, a smart automobile console, and advanced phone devices with additional functionality.

Client devices 120, 122, 124 may execute the UC client application 130 to facilitate communications between users. A user may interact with the UC client application through controls displayed by the application such as call button 132. The user may interact with the call button through a touch action 134. The UC client application 130 may integrate input capability of the device 120 and enable interactivity such as the touch action 134 based on the available input capabilities of the device 120. Input type provided by client devices 120, 122, and 124 are not limited to touch input but may include keyboard, audio, visual, gesture, pen, and similar ones.

The UC system shown in diagram 100 may include a number of servers performing different tasks. For example, UC control server 114 may reside in a perimeter of a network(s) 110 and enable connectivity through the network(s) 110 with external users or server 102 and 112. Server 102 may execute a CRM application maintaining customer information such as sales, inventory, purchases, and similar ones. The CRM application may manage and present expansive customer related information including organizational transactions, relationships, and analysis information. Analysis information may include sales history, present consumption trends, and future sales predictions based on customer transactions.

The server 112 may host contextual information. Contextual information may include data associated with customers, transactions, etc. An example may include a contact data store hosting contact information including contacts' first name, last name, email address(es), phone number(s), credentials for communication applications, and similar ones. Another example may include an organizational information data store hosting data associated organizational members and relations. The contextual information hosted by server 112 may be utilized by the CRM application or UC client application 130 for integration with communication sessions. In an example scenario, CRM application may retrieve contextual information associated with a contact (i.e.: a customer) from a human resources data store hosted by server 112 and integrate contact attributes from the contextual information into the stored contact information.

UC control server 106 may also act as a Session initiation Protocol (SIP) user agent. In a UC system, users may have one or more identities (such as a call identifier), which is not necessarily limited to a phone number. The identity may take any form depending on the integrated networks, such as a telephone number, a Session Initiation Protocol (SIP) Uniform Resource Identifier (URI), or any other identifier. While any protocol may be used in a UC system, SIP is a commonly used method. SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer. Various components of the system may communicate using protocols like SIP, hypertext transport protocol (HTTP), and comparable ones.

While the example system FIG. 1 has been described with specific components UC control server 106, server 102 executing the CRM application, and server 112 hosting contextual information, embodiments are not limited to these components or system configurations and can be implemented with other system configuration employing fewer or additional components. An alternate example, the UC control server 106 may execute the CRM application and host contextual information. In another alternate example, the client devices 120, 122, and 124 may be enabled to access the server 102 executing the CRM application directly and retrieve contextual information associated with contacts from local data stores. Furthermore, embodiments are not limited to UC systems. The approaches discussed here may be applied to any data exchange in a networked communication environment using the principles described herein.

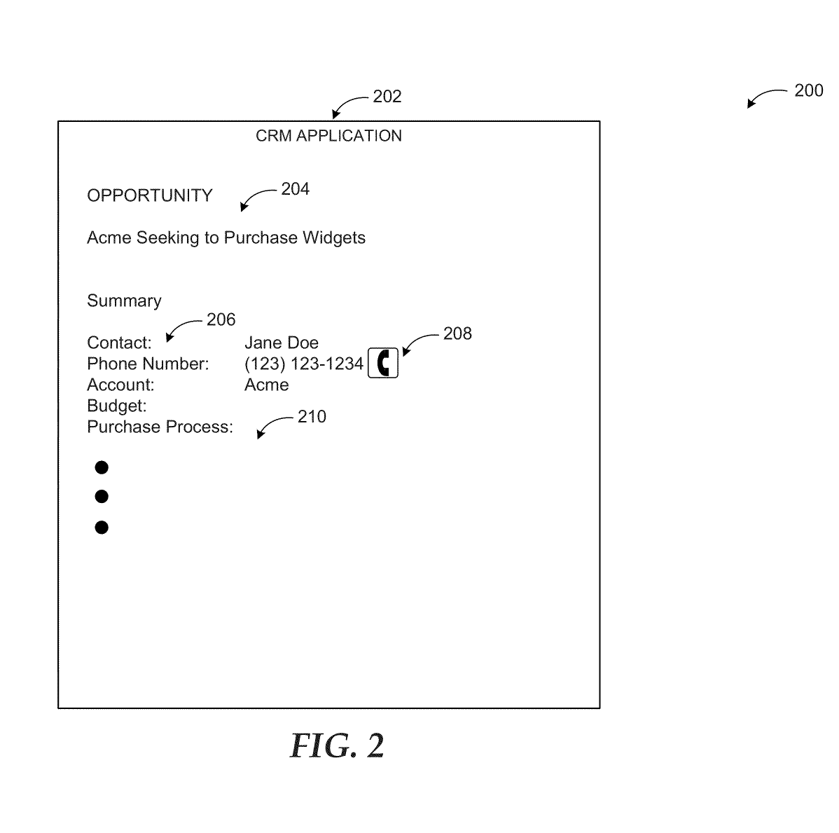

FIG. 2 is an example user interface of a CRM application providing communication controls to integrate CRM information with communication sessions, according to embodiments. Diagram 200 illustrates an example CRM application providing a communication control 208 to provide a click to call feature associated with a CRM entity such as an opportunity.

An opportunity is a CRM entity encompassing sales information, activities, and participants associated with sale of a product. An example may include opportunity 204 for a future sale of a product. The CRM application 202 may display an opportunity view within a client interface to a user, in response to user provided input matching the opportunity 204. The client interface may be a local interface displayed on a device in interaction with the user. Alternatively the client interface may be a web browser displaying a CRM web application hosted by a CRM server.

The CRM application 202 may display contextual information associated with the opportunity including a contact 206. Additional contextual information associated with the contact 206 may be displayed including phone number, account, budget, purchase process, and similar ones. Budget value may include a number range. The purchase process may include a purchase order, a payment method, and similar one. Additional contextual information associated with the opportunity may be displayed by the CRM application 202 tiding sales information associated with the opportunity. The CRM application 202 may also display relationship information associated with contact 206 and other entities such as other contacts within an organization associated with the contact 206.

In addition, the CRM application may display a communication control 208 to late a call with the contact 206. Activation of the communication control 208 may launch a UC client application. Establishing the call may be delegated to the UC client application. Alternatively, activation of the communication control 208 may trigger a present UC client application to initiate the call. Initiating the call through a communication control 208 may be defined as a click to call functionality.

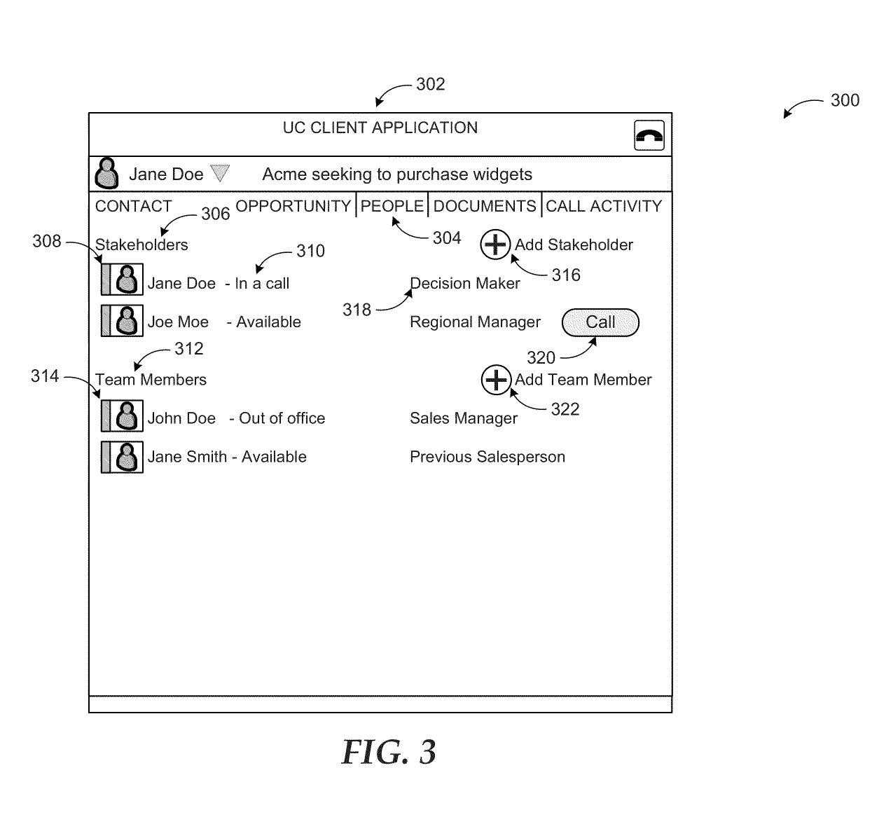

FIG. 3 illustrates an example of integrating CRM information with communication sessions presenting contacts associated with the opportunity, according to embodiments.

As shown in diagram 300, contacts associated with an opportunity may be displayed in a UT such as a people view 304. Contextual information associated with the contacts may be organized in the people view 304 based on an organizational category. The organizational category for contacts including stake holders 306 and team members 312 may be retrieved from the contextual information.

Presence information associated with each contact may also be retrieved from the contextual information and presented in a summary description 310 adjacent to the contacts within the people view. In addition, the presence information may be presented as a graphic 308 and 314. The graph 308 and 314 may be displayed in a different color associated with a presence status for contacts associated with the opportunity.

The UC client application may also retrieve role information 318 from the contextual information associated with the contacts. The role information 318 may be displayed adjacent to each contact. The displayed contextual information associated with the contacts may be edited and updated by the user. The UC client application may provide controls to apply an edit and an update to the contextual information including contacts' name, presence status, organizational category, and role. The edit and update to the contextual information may be transmitted to the CRM application for storage.

In addition, the UC client application may present add controls 316 and 322 to add a stakeholder, a team member, an external contact, a partner, and similar ones to the contacts. In response to activation of the add controls, the UC client application may present an empty contacts form to collect new contextual information associated with a new contact. The new contextual information may be transmitted to the CRM application to store as a new contact associated with the opportunity. Alternatively, UC client application may detect a drag and drop action of a contact graphic or representation from an external application on to the add control. The UC client application may retrieve new contextual information associated with the external contact from the external application. The new contextual information associated with the external contact may be sent to the CRM application for storage as a new contact associated with the opportunity.

The UC client application 302 may also display a communication control 320 associated with one or more the contacts in the people 304. The application may initiate an operation including establish a new call with the contact, start a message session, add the contact into an existing call, and similar ones in response to detecting an activation of the communication control 320.

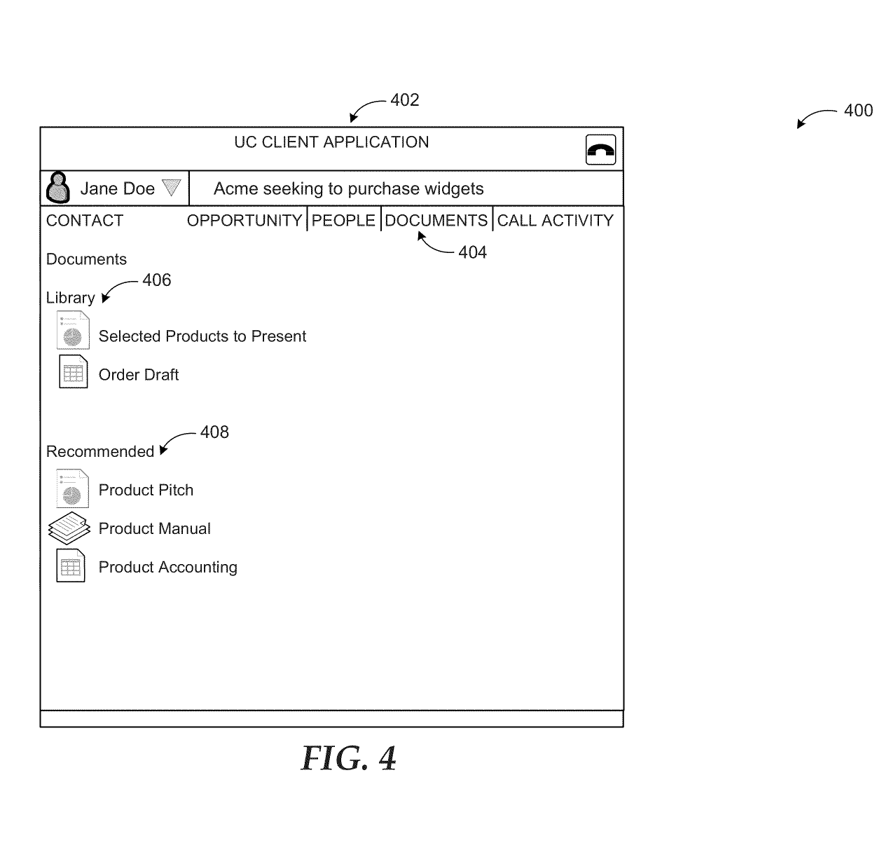

FIG. 4 illustrates another example of integrating CRM information to communications sessions presenting documents associated with an opportunity, according to embodiments.

As shown in diagram 400, documents may be presented in categories including library and recommended within another UI such as the documents view 404. Documents associated with the opportunity may be retrieved from the CRM application and presented within the library category 406. The CRM application may associate the documents with the opportunity by assigning a classification such as the library category 406 to the documents. The documents may be retrieved and presented based on the classification assigned by the CRM application including the library category 406. In addition, documents may be presented in the recommended category 408 based on document history retrieved from the contextual information. The document history may specify information such as prior use associated with the opportunity. In addition, content of the documents retrieved from the CRM application may be scanned for matches with the contextual information. In response to meeting a match criteria such as a predetermined number of matched terms, the documents may be assigned to the recommended category 408 and displayed in the documents view.

In addition, the documents may be presented with document controls to share the documents with participants of the call. The participants of the call may include the initial contact and later contacts added to the call. The UC client application 402 may present the document controls to open the documents locally, send the documents to a participant of the call, and to present the documents to participants of the call.

The UC client application 402 may also monitor a document update and a document edit associated with the documents. The document update and the document edit associated with the documents may be transmitted to the CRM application for storage in association with the opportunity. In addition the UC client application 402 may provide add controls to add new documents in the documents view. New documents may be transmitted to the CRM application for storage in association with the opportunity.

The UC client application 402 may also transmit other contextual information associated with: participants of the call, additional modalities of communication associated with the call, a subset of the documents presented during the call, another subset of the documents shared during the call to the CRM application for storage in association with the opportunity. The additional modalities of communication may include an instant message (IM) session between a subset of participants. The additional modalities are not limited to an IM session may include other communication modalities including but not exclusive to audio, video, text based, file sharing, and similar modalities.

The example scenarios and schemas in FIG. 2 through 4 are shown with specific components, data types, and configurations. Embodiments are not limited to systems according to these example configurations. Integrating CRM information with communication sessions may be implemented configurations employing fewer or additional components in applications and user interfaces. Furthermore, the example schema and components shown in FIG. 2 through 4 and their subcomponents may be implemented in a similar manner with other values using the principles described herein.

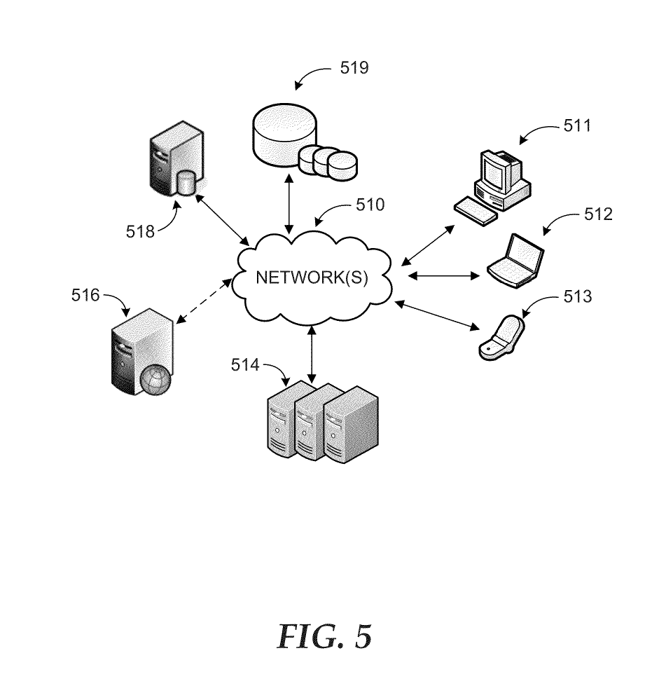

FIG. 5 is an example networked environment, where embodiments may be implemented. A system prioritizing multi-modal communication over wireless networks may be implemented via software executed over one or more servers 514 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may facilitate communications via application(s) executed by servers 514, or on individual server 516. A UC client application executed on client devices may initiate a call with a contact associated with an opportunity stored in the CRM application. The UC client application may receive contextual information and documents associated with the opportunity from the CRM application. Contextual information of contacts associated with the opportunity may be displayed in a people view while documents associated with the opportunity may be displayed in a documents view. The application may store the updates or additional data associated with the contextual information in data store(s) 519 directly or through database server 518 associated with the CRM application.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to integrate CRM information with communication sessions. Furthermore, the networked environments discussed in FIG. 5 are for illustration purposes only. Embodiments are not limited to the example applications, modules, or processes.

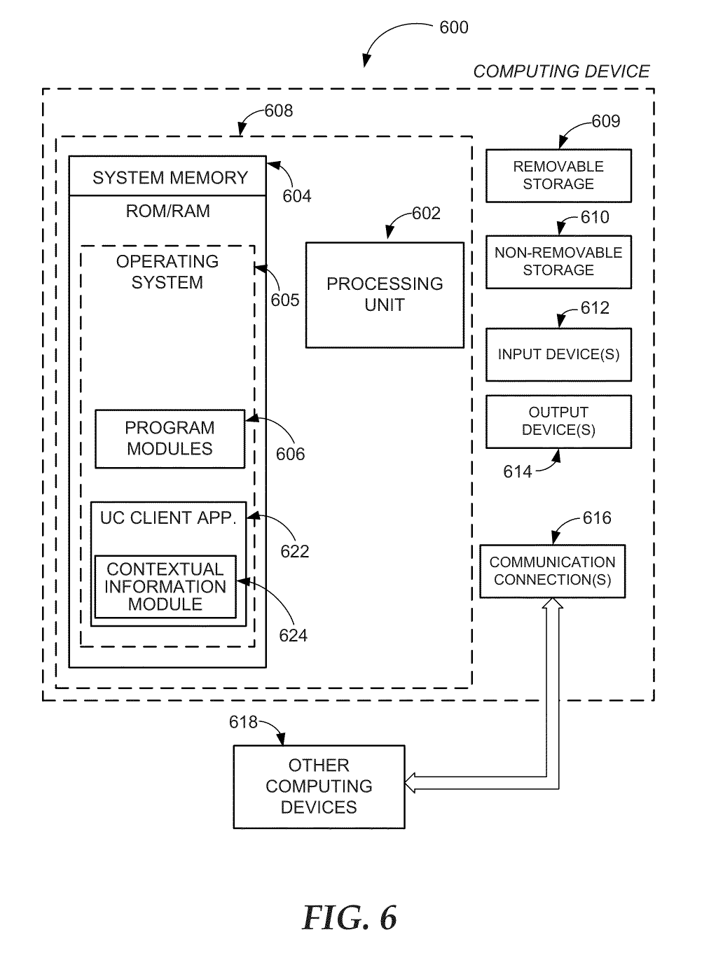

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any computing device executing a UC client application according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, UC client application 622, and contextual information module 624.

UC client application 622 may integrate CRM information with communication sessions. The UC client application 622 may initiate a call and receive contextual information and documents associated with an opportunity that is associated with the call. Contextual information module 624 may analyze the contextual information and the documents for presentation by the UC client application 622. The UC client application 622 may present the contextual information associated with contacts that are associated with an opportunity in a people view and documents associated with the opportunity in a documents view. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, an optical capture device for detecting gestures, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

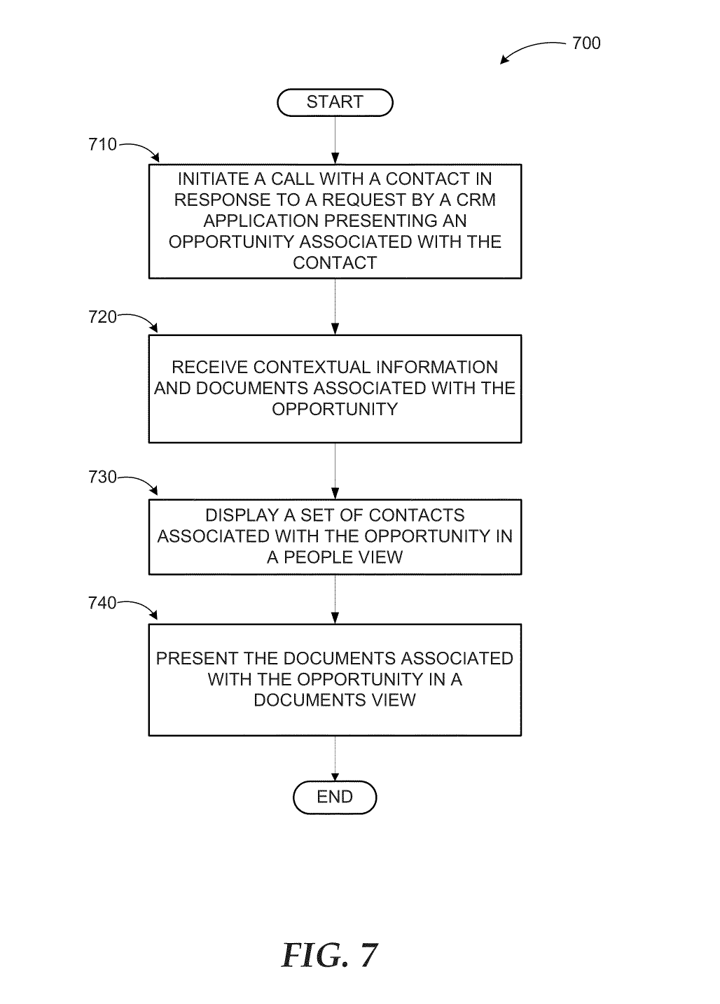

FIG. 7 illustrates a logic flow diagram for a process of integrating CRM information to communication sessions according to embodiments. Process 700 may be implemented on UC client application in interaction with a CRM application.

Process 700 begins with operation 710 initiating a call with a contact in response to a request by a CRM application. The call may be initiated an response to receiving a call identifier such as a phone number. At operation 720, the UC client application may receive contextual information and documents associated with the opportunity. The contextual information may include attribute and relationships associated with the opportunity and the documents. Next, at operation 730, a set of contacts associated with the opportunity may be displayed in a people view. The contacts may be grouped based on organizational category including stake holders and team members. The documents associated with the opportunity may be displayed in a documents view at operation 740.

The operations included in process 700 are for illustration purposes. A UC client application may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for integrating customer relationship management (CRM) information to communication sessions, the method comprising:
initiating a call with a contact in response to a request by a CRM application;
receiving contextual information and documents associated with an opportunity;
displaying a set of contacts associated with the opportunity within a user interface (UI) including a people view; and
presenting the documents associated with the opportunity within another UI including a documents view.

2. The method of claim 1, further comprising:
organizing the set of contacts based on an organization category including at least one of: a stakeholder, a team member, an external contact, and a partner.

3. The method of claim 1, further comprising:
retrieving presence information associated with the set of contacts from the contextual information; and
presenting a summary description of the presence information adjacent to the set of contacts within the people view.

4. The method of claim 3, further comprising:
displaying a graphic presenting the presence information adjacent to the set of contacts; and
displaying a color associated with a presence status of the presence information within the graphic.

5. The method of claim 1, further comprising:
retrieving role information associated with the set of contacts from the contextual information; and
displaying the role information adjacent to the set of contacts in the people view.

6. The method of claim 1, further comprising:
providing controls to apply an edit and an update to the contextual information; and
transmitting the edit and the update to the CRM application for storage.

7. The method of claim 1, further comprising:
presenting add controls to add at least one of: a stakeholder, a team member, an external contact, and a partner in the people view.

8. The method of claim 7, further comprising:
presenting a contacts form to collect a new contextual information associated with a new contact in response to an activation of one of the add controls; and
transmitting the new contextual information to the CRM application for storage as the new contact associated with the opportunity.

9. The method of claim 7, further comprising:
retrieving new contextual information associated with a new contact from an external application in response to detecting a drag and drop action of a graphic associated with the new contact on to one of the add controls; and
transmitting the new contextual information to the CRM application for storage as the new contact associated with the opportunity.

10. The method of claim 1, further comprising:
displaying a communication control associated with the set of contacts; and
in response to detecting an activation of the communication control, initiating an operation including one of:
establishing a new call with one of the set of contacts;
starting a message session with one of the set of contacts; and
adding one of the set of contacts into the call.

11. A computing device for integrating customer relationship management (CRM) information to communication sessions, the computing device comprising:
a memory;
a processor coupled to the memory, the processor executing a unified communications (UC) client application in conjunction with instructions stored in the memory, wherein the UC client application is configured to:
initiate a call with a contact in response to a request by a CRM application;
receive contextual information and documents associated with an opportunity;
display a set of contacts associated with the opportunity within a user interface (UI) including a people view;
present the documents associated with the opportunity within another UI including a documents view;
provide controls to apply an edit and an update to the contextual information; and
transmit the edit and the update to the CRM application for storage.

12. The computing device of claim 11, wherein the UC client application is further configured to:
retrieve documents associated with the opportunity based on a classification assigned by the CRM application including a library category; and
present the document within the library category.

13. The computing device of claim 11, wherein the UC client application is further configured to:
retrieve a document history associated documents from the contextual information; and
present the documents in a recommended category based on the document history specifying prior use associated with the opportunity.

14. The computing device of claim 13, wherein the client application is further configured to:
scan content of the documents for matches with the contextual information; and
assign the documents to the recommended category in response to meeting a match criteria including a predetermined number of matched terms.

15. The computing device of claim 11, wherein the UC client application is further configured to:
present document controls for an operation including one of:
open the documents locally;
send the documents to a participant of the call; and
present the documents to participants of the call.

16. The computing device of claim 11, wherein the UC client application is further configured to:
monitor the documents for at least one of: a document update and a document edit; and
transmitting the at least one of: the document update and the document edit to the CRM application for storage in association with the opportunity.

17. The computing device of claim 11, wherein the UC client application is further configured to:
provide add controls to add new documents within the documents view; and
transmit the new documents CRM application for storage in association with the opportunity

18. A computer-readable memory device with instructions stored thereon for integrating customer relationship management (CRM) information to communication sessions, the instructions comprising:
initiating a call with a contact in response to a request by a CRM application;
receiving contextual information and documents associated with an opportunity;
displaying a set of contacts associated with the opportunity within a user interface (UI) including a people view;
retrieve documents associated with the opportunity based on a classification assigned by the CRM application including a library category;
presenting the documents within the library category within another UI including a documents view;
providing controls to apply an edit and an update to the contextual information; and
transmitting the edit and the update to the CRM application for storage.

19. The computer-readable memory device of claim 18, wherein the instructions further comprise:
retrieving presence information associated with the set of contacts from the contextual information;
presenting a summary description of the presence information adjacent to the set of contacts within the people view;
displaying a graphic presenting the presence information adjacent to the set of contacts; and
displaying a color associated with a presence status of the presence information within the graphic.

20. The computer-readable memory device of claim 18, wherein the instructions further comprise:
transmitting other contextual information associated with at least one of: participants of the call, additional modalities of communication associated with the call, a subset of the documents presented during the call, and another subset of the documents shared during the call to the CRM application for storage in association with the opportunity.
